(19) United States
(12) Patent Application Publication
(10) Pub. No.: US 2012/0127864 A1
(43) Pub. Date: May 24, 2012

(54) PERFORMING POLICING OPERATIONS IN PACKET TIME

(75) Inventors: Hamid Assarpour, Arlington, MA (US); Mike Craren, Holliston, MA (US); Rich Modelski, Hollis, NH (US)

(73) Assignee: AVAYA INC., Basking Ridge, NJ (US)

(21) Appl. No.: 12/951,627

(22) Filed: Nov. 22, 2010

(51) Int. Cl. H04L 12/56

(52) U.S. Cl. 370/235.1

(57) ABSTRACT

Methods and apparatus provide for a Packet Policer. The Packet Policer determines a first amount of tokens based on an interval occurring between receipt of a first packet and receipt of a second packet, where the first packet was received before the second packet. The Packet Policer determines a second amount of tokens based on a size of the second packet. The Packet Policer then updates a token bucket with the first amount of tokens as the second amount of tokens is removed from the token bucket.

### BACKGROUND

Data communication networks may include various computers, servers, nodes, routers, switches, hubs, proxies, and other devices coupled to and configured to pass data to one another. These devices are referred to herein as “network devices,” and may provide a variety of network resources on a network. Data is communicated through data communication networks by passing protocol data units (such as data packets, network data packets, packets, cells, frames, or segments) between the network devices over communication links on the network. A particular protocol data unit may be handled by multiple network devices and cross multiple communication links as it travels between its source and its destination over the network. Hosts such as computers, telephones, cellular telephones, Personal Digital Assistants, and other types of consumer electronics connect to and transmit/receive data over the communication network and, hence, are users of the communication services offered by the communication network.

A packet is a basic unit of communication over a digital network. A packet is also called a datagram, a segment, a block, a cell or a frame, depending on the protocol. When data has to be transmitted, it is broken down into similar structures of data, which are reassembled to the original data chunk once they reach their destination. Packets vary in structure depending on the protocols implementing them. VoIP uses the IP protocol, and hence IP packets. On an Ethernet network, for example, data is transmitted in Ethernet frames. The structure of a packet depends on the type of packet it is and on the protocol. Normally, a packet has a header and a payload. The header keeps overhead information about the packet, the service and other transmission-related things. For example, an IP packet includes the source IP address, the destination IP address, the sequence number of the packets, the type of service, ports for use in identifying a distinct connection between users, various flags and a variety of other types of data. The payload is the data carried in a packet.

Network devices (or network elements) are typically implemented to have a control plane that controls operation of the network device and a data plane that handles traffic flowing through the network. The data plane typically will have a collection of line cards having ports that connect to links on the network. Data is received at a particular port, switched within the data plane, and output at one or more other ports onto other links on the network. To enable the data to be handled quickly, the data plane is typically implemented in hardware so that all of the decisions as to how to handle the data are performed using hardware lookups, etc.

The packets are transferred across the network in accordance with a particular protocol, such as the Internet protocol (IP). Internet Protocol version 4 (IPv4) is the fourth revision in the development of the Internet Protocol (IP) and it is the first version of the protocol to be widely deployed. Together with IPv6, it is at the core of standards-based internetworking methods of the Internet. IPv4 is still by far the most widely deployed Internet Layer protocol.

### BRIEF DESCRIPTION

A data packet policing algorithm is used to control the rate of data packet traffic sent into a network. Various data packet policing algorithms are used in order to guarantee levels of network service offered to customers and to manage the amount of network capacity consumed by each respective network customer. Typically, a conventional data packet policing algorithm uses an update step and a depletion step. The update step and the depletion step are separate independent processes in and of themselves. Thus, each step incurs its own processing burden. In addition, with conventional data packet policing algorithms, the memory bandwidth utilized tends to be redundant for each step as well—since both steps (i.e. the update step and the deplete step, individually) require a read-from memory operation and a read/modify write-to memory operation.

Techniques discussed herein significantly overcome the processing burdens and memory bandwidth complications of conventional data packet policing algorithms. As will be discussed further, certain specific embodiments herein are directed to a Packet Policer where the update step and the deplete step implicitly occur in a single process by executing token amount calculations based on the current rate at which data packets have been received. This process is typically also used to forward data packets. Thus, various embodiments of the Packet Policer require only a single read-from operation and a single read/modify write-to operation. In other words, with respect to various embodiments of the Packet Policer, the update step and the delete step are not executed as separate, individual processes.

Generally, the techniques disclosed herein provide a computer system and/or software, in the form of a Packet Policer, that determines a first amount of tokens based on an interval occurring between receipt of a first packet and receipt of a second packet, where the first packet was received before the second packet. The Packet Policer determines a second amount of tokens based on a size of the second packet. The Packet Policer then updates a token bucket with the first amount of tokens as the second amount of tokens is removed from the token bucket. It is understood that the Packet Policer can interact with (or be included within) any type of network device or network element.

In various embodiments, the Packet Policer initially fills a token bucket with a pre-determined maximum amount of tokens. The token bucket will never have more tokens than the pre-determined maximum amount of tokens. Each token in the token bucket is treated as being equivalent one byte in a data packet. Also, the Packet Policer stores the time of the most recent update made to the token bucket (i.e. the last time tokens were inserted into the token bucket).

A new data packet is later received and the new data packet is considered a “conformant packet” when the number of bytes in the new data packet are less than or equal to the amount of the tokens currently in the token bucket. If the byte-size of the new data packet is greater than the amount of tokens currently in the token bucket, then the new data packet is eligible to be dropped.

Regardless of whether the new data packet is a “conformant packet” or is to be dropped, the Packet Policer determines an interval of time that has occurred between the most recent token bucket update and receipt of the new data packet. The Packet Policer determines a product of that interval of time and a configured rate. The configured rate is a predetermined rate describing an amount of tokens for a given period of time. The product of the interval of time and the configured rate represents an amount of tokens to be inserted into the token bucket in order to update the token bucket regardless of whether the packet is conformant or not.

It is noted that, if the product interval of time and the configured rate create a number that is greater than the pre-determined maximum amount of tokens, then the Packet Policer updates the token bucket with the pre-determined maximum amount of tokens.

The Packet Policer detects a size of the new data packet and, for each byte in the new data packet, the Packet Policer will deplete a token from the token bucket. The Packet Policer depletes tokens from the token bucket as it updates the token bucket. Thus, the Packet Policer's “update step” and “deplete step” occur in a single process—thereby incurring a lower processing burden and using less memory bandwidth than conventional packet policing algorithms. It should be noted that the deplete step only occurs if the packet is conformant.

Other embodiments disclosed herein include software programs to perform the steps and operations summarized above and disclosed in detail below. One such embodiment comprises a computer program product that has a computer-readable medium (e.g., tangible computer-readable medium) including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as array of logic gates implemented in a Field Programmable Gate Array [FPGA] or an Application Specific Integrated Circuit (ASIC). The software or firmware or other such configurations can be installed onto a computerized device to cause the computerized device to perform the techniques explained as embodiments disclosed herein.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Avaya, Inc. of Lincroft, New Jersey.

Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

Note also that this Brief Description section herein does not specify every embodiment and/or incrementally novel aspect of the present disclosure or claimed invention. Instead, this Brief Description only provides a preliminary discussion of different embodiments and corresponding points of novelty over conventional techniques. For additional details and/or possible perspectives (permutations) of the invention, the reader is directed to the Detailed Description section and corresponding figures of the present disclosure as further discussed below.

### BRIEF DESCRIPTION OF THE DRAWINGS

The foregoing and other objects, features and advantages of the invention will be apparent from the following more particular description of embodiments of the methods and apparatus for a Packet Policer, as illustrated in the accompanying drawings and figures in which like reference characters refer to the same parts throughout the different views. The drawings are not necessarily to scale, with emphasis instead being placed upon illustrating the embodiments, principles and concepts of the methods and apparatus in accordance with the invention.

FIG. 1 is an example block diagram illustrating an architecture of a computer system that executes, runs, interprets, operates or otherwise performs a Packet Policer application and/or Packet Policer process according to embodiments herein.

FIG. 2 is an example block diagram of a Packet Policer . . . according to embodiments herein.

FIG. 3 is a flowchart of an example of processing steps performed by a Packet Policer to modify an amount of tokens in a token bucket based on packet time according to embodiments herein.

FIG. 4 is a flowchart of an example of processing steps performed by a Packet Policer to determine an amount of tokens to be added to a token bucket and an amount of tokens to be removed from the token bucket according to embodiments herein.

FIG. 5 is a flowchart of an example of processing steps performed by a Packet Policer to determine whether a packet should be dropped according to embodiments herein.

### DETAILED DESCRIPTION

Generally, the techniques disclosed herein provide a computer system and/or software in the form of a Packet Policer that determines a first amount of tokens based on an interval occurring between receipt of a first packet and receipt of a second packet, where the first packet was received before the second packet. The Packet Policer determines a second amount of tokens based on a size of the second packet. The Packet Policer then updates a token bucket with the first amount of tokens as the second amount of tokens is removed from the token bucket.

For example, in various embodiments, the Packet Policer utilizes a data structure known as a token bucket. The token bucket contains a count of tokens to be updated and replenished as data packets are received, routed and/or dropped. The token bucket is associated with a configured rate, which is a predetermined rate at which tokens are inserted into the token bucket, and corresponds to the rate that data packets are allowed into a network. Initially, the token bucket is configured with the maximum value (i.e. a maximum amount of tokens allowed in the token bucket). Each token can be equivalent to one or more bytes in a data packet.

The Packet Policer allows a newly received data packet to proceed if the amount of tokens in the token bucket will be greater than zero after depleting an amount of tokens equivalent to the newly received data packet's size. In such a case, the data packet is considered a “conformant packet.” If token depletion caused by the byte size of the newly received data packet will result in the amount of tokens in the token bucket to fall below zero, that data packet is considered expendable and can be dropped.

In addition, the Packet Policer's “update step” and “delete step” occur during the same process—as opposed to conventional policing algorithms. The “update step” is performed in what can be described as “packet time.” In other words, the Packet Policer saves a time of a recent token bucket update. When a new data packet is received, the Packet Policer takes note of the current time. A time interval is determined with respect to the time of the recent token bucket update and the time of receipt of the new data packet.

The Packet Policer determines the product of the time interval and the configured rate in order to calculate a first number of tokens to be added to the token bucket. A second number of tokens is determined based on the size (i.e. amount of bytes) in the new data packet. If the packet is conformant, the Packet Policer inserts the first number of tokens into the token bucket as it removes the second number of tokens from the token bucket. If the packet is not conformant (and is eligible to be dropped), the Packet Policer only inserts the first number of tokens. The Packet Policer stores the time of the current token bucket update to be used upon receipt of another incoming data packet.

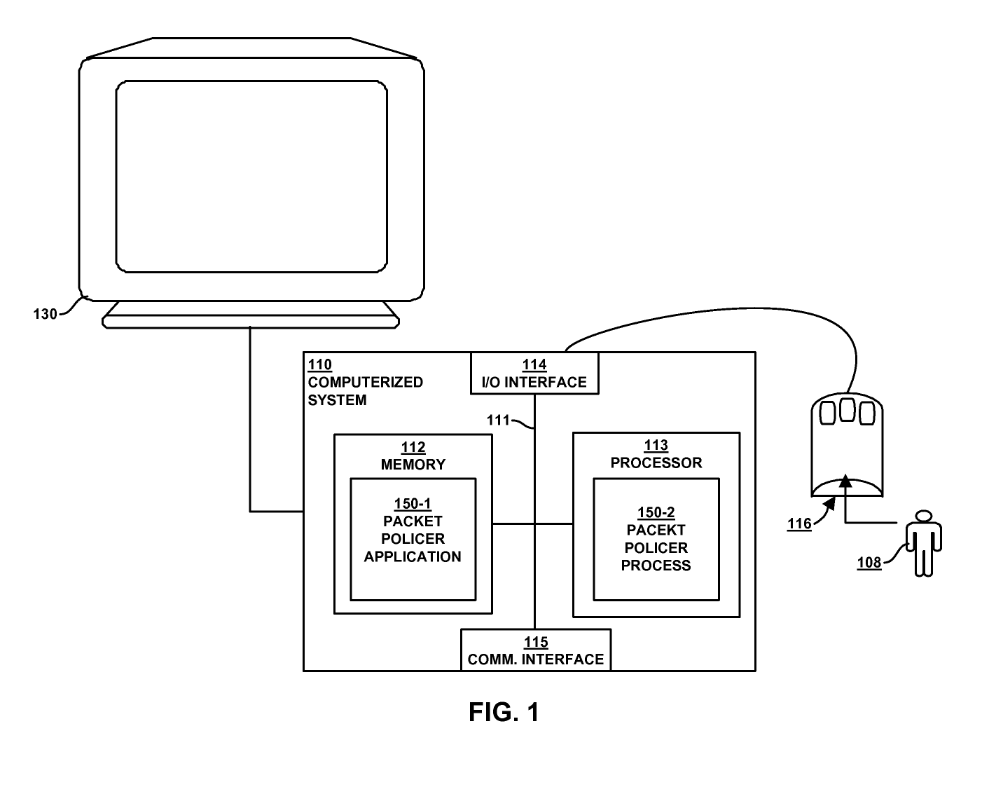

FIG. 1 is an example block diagram illustrating an architecture of a computer system 110 that executes, runs, interprets, operates or otherwise performs a Packet Policer application 150-1 and/or Packet Policer process 150-2 (e.g. an executing version of a Packet Policer 150 as controlled or configured by user 108) according to embodiments herein.

Note that the computer system 110 may be any type of computerized device such as a personal computer, a client computer system, workstation, portable computing device, console, laptop, network terminal, etc. This list is not exhaustive and is provided as an example of different possible embodiments.

In addition to a single computer embodiment, computer system 110 can include any number of computer systems in a network environment to carry the embodiments as described herein.

As shown in the present example, the computer system 110 includes an interconnection mechanism 111 such as a data bus, motherboard or other circuitry that couples a memory system 112, a processor 113, an input/output interface 114, and a display 130. If so configured, the display can be used to present a graphical user interface of the Packet Policer 150 to user 108. An input device 116 (e.g., one or more user/developer controlled devices such as a keyboard, mouse, touch pad, etc.) couples to the computer system 110 and processor 113 through an input/output (I/O) interface 114. The computer system 110 can be a client system and/or a server system. As mentioned above, depending on the embodiment, the Packet Policer application 150-1 and/or the Packet Policer process 150-2 can be distributed and executed in multiple nodes in a computer network environment or performed locally on a single computer.

During operation of the computer system 110, the processor 113 accesses the memory system 112 via the interconnect 111 in order to launch, run, execute, interpret or otherwise perform the logic instructions of the Packet Policer application 150-1. Execution of the Packet Policer application 150-1 in this manner produces the Packet Policer process 150-2. In other words, the Packet Policer process 150-2 represents one or more portions or runtime instances of the Packet Policer application 150-1 (or the entire application 150-1) performing or executing within or upon the processor 113 in the computerized device 110 at runtime.

The Packet Policer application 150-1 may be stored on a computer readable medium (such as a floppy disk), hard disk, electronic, magnetic, optical, or other computer readable medium. It is understood that embodiments and techniques discussed herein are well suited for other applications as well.

Those skilled in the art will understand that the computer system 110 may include other processes and/or software and hardware components, such as an operating system. Display 130 need not be coupled directly to computer system 110. For example, the Packet Policer application 150-1 can be executed on a remotely accessible computerized device via the communication interface 115.

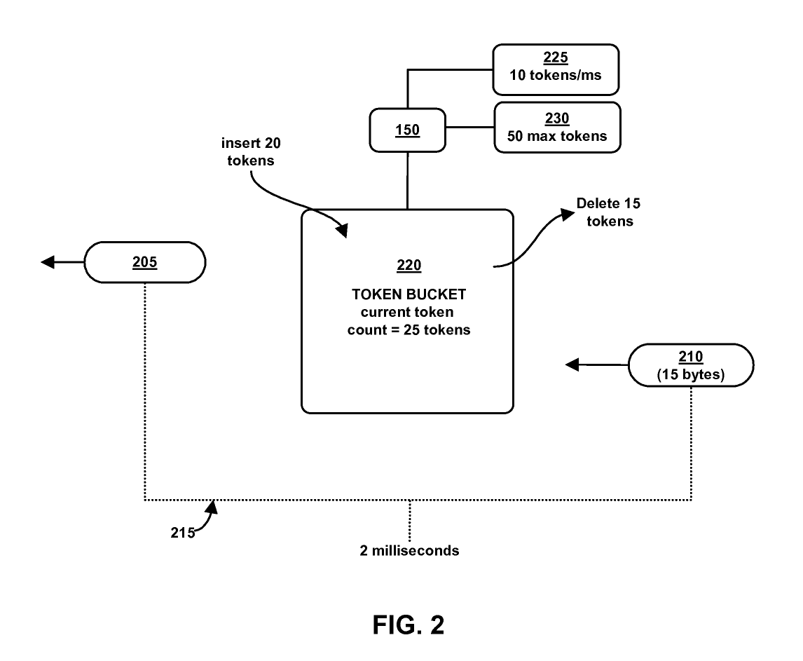

FIG. 2 is an example block diagram of a Packet Policer 150 according to embodiments herein. It is understood that FIG. 2 can be understood as illustrating activity regarding multiple data packets 205, 210 handled by any kind of network device(s).

In FIG. 2, a token bucket 220 has a current token count of 25 tokens. The configured rate 225 is 10 tokens per millisecond and the maximum amount of tokens 230 the token bucket can ever have is 50 tokens. A first conformant data packet 205 has since been received and routed by the network device. The data packet's 205 receipt necessitated an update and depletion of tokens via the Packet Policer 150. It is understood that the time at which the token bucket update occurred, due to receipt of the data packet 205, has been stored by the Packet Policer 150.

The network device (that interacts with the Packet Policer 150) receives a second conformant data packet 210, which has a size of 15 bytes. The time of receipt of the second conformant data packet 210 is 2 milliseconds after the update of the token bucket 220 occurred due to receipt of the first conformant data packet 205. Hence, the interval of time between the most recent token bucket update and receipt of the second conformant data packet 210 is 2 milliseconds.

The Packet Policer 150 determines the product of that interval of time and the configured rate (i.e. 2 milliseconds*10 tokens/millisecond). The product equals 20 tokens. The Packet Policer 150 deletes an amount of tokens, from the token bucket 220, that is equal to the size (i.e. 15 bytes) of the second conformant data packet 210. As the Packet Policer 150 deletes 15 tokens from the token bucket 220, the Packet Policer 150 inserts 20 tokens into the token bucket 220. The Packet Policer 150 thereby saves the time of the most recent token bucket update, that is, the time at which the 20 tokens were inserted.

Further, it is understood that, regardless of the product of an interval between data packets and the configured rate 225, no amount of tokens used to update the token bucket 220 are to exceed the maximum amount of tokens 230.

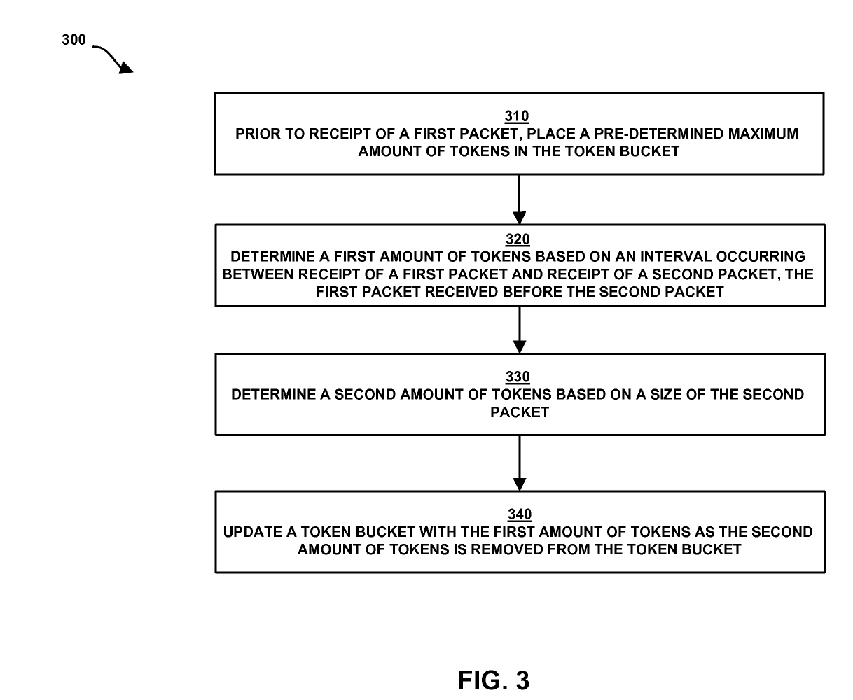

It is noted that FIGS. 3, 4 and 5 illustrate flowcharts of processing of various embodiments of the Packet Policer 150. The rectangular elements in flowcharts 300, 400 and 500 (in FIGS. 3, 4, and 5—respectively) denote “processing blocks” and represent computer software instructions or groups of instructions upon a computer readable medium. Additionally, the processing blocks represent steps performed by hardware such as a computer, digital signal processor circuit, application specific integrated circuit (ASIC), Field Programmable Gate Array [FPGA], etc. As the processing in the flowcharts is described, reference will be made various aspect illustrated in FIGS. 1-9, which show examples of this processing.

Flowcharts 300, 400, 500 do not necessarily depict the syntax of any particular programming language. Rather, flowcharts 300, 400, 500 illustrate the functional information one of ordinary skill in the art requires to fabricate circuits or to generate computer software to perform the processing required in accordance with the present invention.

It will be appreciated by those of ordinary skill in the art that unless otherwise indicated herein, the particular sequence of steps described is illustrative only and may be varied without departing from the spirit of the invention. Thus, unless otherwise stated, the steps described below are unordered, meaning that, when possible, the steps may be performed in any convenient or desirable order.

FIG. 3 is a flowchart 300 of an example of processing steps performed by a Packet Policer 150 to modify an amount of tokens in a token bucket based on packet time according to embodiments herein.

At step 310, prior to receipt of a first packet 205, the Packet Policer 150 places a pre-determined maximum amount of tokens 230 in a token bucket 220.

At step 320, the Packet Policer 150 determines a first amount of tokens based on an interval 215 occurring between receipt of a first packet 205 and receipt of a second packet 210, where the first packet 205 is received before the second packet 210. Specifically, the interval 215 can be based on the amount of time occurring between receipt of the second data packet 210 and the most recent token bucket 220 update.

At step 330, the Packet Policer 150 determines a second amount of tokens based on a size of the second packet 210. For example, the Packet Policer 150 accounts at least one token currently in the token bucket 220 for every byte in the data packet 210.

At step 340, the Packet Policer 150 updates the token bucket 220 with the first amount of tokens as the second amount of tokens is removed from the token bucket 220. It is understood that, in order to update the token bucket 220 and remove tokens from the token bucket 220, the packet 210 must be conformant. If the packet 210 is not conformant (i.e. its byte size corresponds to more tokens that are currently in the token bucket 220), the Packet Policer 150 updates the token bucket 220 without removing tokens from the token bucket 220.

When performing the update and depletion steps as described herein, the Packet Policer 150 performs a single read-from operation and a single read/modify write-to operation. In addition, whenever the Packet Policer 150 updates the token bucket 220 with newly inserted tokens, the Packet Policer 150 stores the time at which that token bucket update occurs.

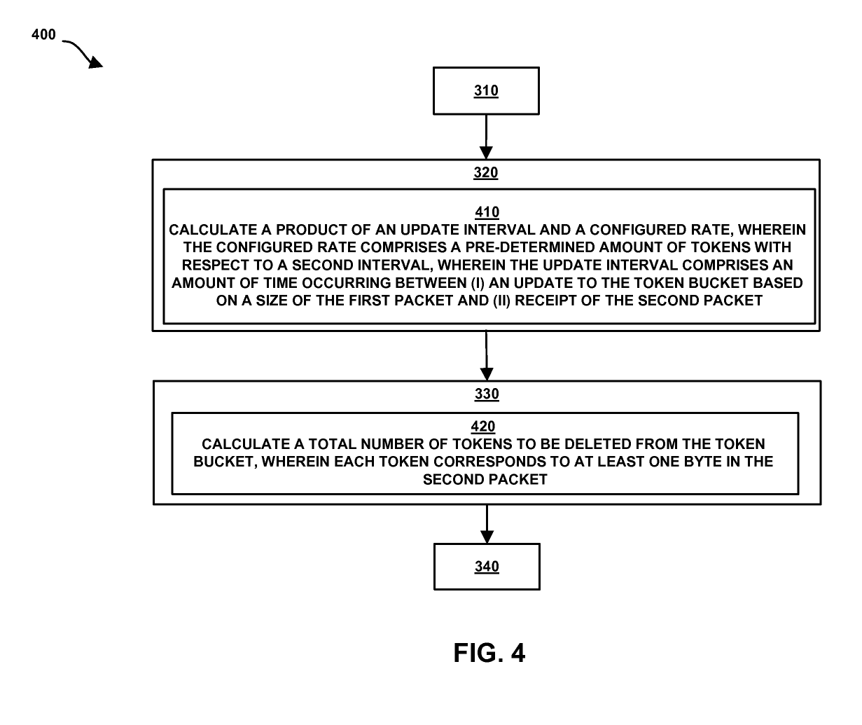

FIG. 4 is a flowchart 400 of an example of processing steps performed by a Packet Policer 150 to determine an amount of tokens to be added to a token bucket and an amount of tokens to be removed from the token bucket according to embodiments herein.

At step 410, the Packet Policer 150 calculates a product of an update interval and a configured rate 225. It is understood that the configured rate 225 comprises a pre-determined amount of tokens with respect to a second interval.

The update interval comprises an amount of time occurring between (i) an update to the token bucket based on a size of the first packet and (ii) receipt of the second packet. The update interval can also represent a time at which a given amount of tokens were inserted into the token bucket 220 in order to ensure the token bucket will have the maximum amount of tokens 230.

At step 420, the Packet Policer 150 calculates a total number of tokens to be deleted from the token bucket 220, wherein each token corresponds to at least one byte in the second packet 210. For example, in some embodiments, the Packet Policer 150 deletes a token from the token bucket 220 for each byte in the second data packet 210.

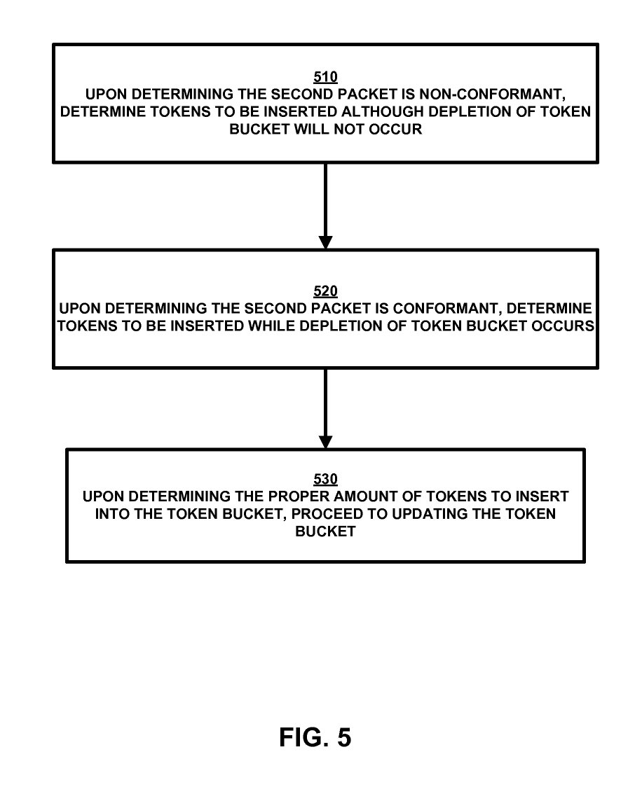

FIG. 5 is a flowchart 500 of an example of processing steps performed by a Packet Policer 150 to determine whether a packet should be dropped according to embodiments herein.

At step 510, if a current number of tokens in the token bucket 220 is less than the total number of tokens to be deleted, the Packet Policer 150 identifies the second packet 210 as eligible to be dropped, or “non-conformant.” For purposes of updating the token bucket 220 based on dropping the second packet 210, the Packet Policer 150 determines an amount of tokens to be inserted into the token bucket 220 from the product of the configured rate and the time interval between the most recent token bucket update and receipt of the non-conformant packet. In various embodiments, upon receipt of a non-conformant packet, the Packet Policer 150 does not apply the depletion step to the token bucket 220—only the update of the token bucket 220 will occur up to the pre-determined maximum amount of tokens.

At step 520, if the current number of tokens in the token bucket 220 is greater than or equal to the total number of tokens to be deleted, the Packet Policer 150 identifies the second packet as a “conformant packet” and determines an amount of tokens to be inserted into the token bucket 220 from the product of the configured rate and the time interval between the most recent token bucket update and receipt of the conformant packet.

At step 530, upon determining the proper amount of tokens to insert into the token bucket 220, Packet Policer 150 proceeds to the step of updating the token bucket (See step 340) and the Packet Policer 150 stores the time at which the latest token bucket update occurred.

The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions.

The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), notebook computer(s), workstation(s) (e.g., Sun, HP), personal digital assistant(s) (PDA(s)), handheld device(s) such as cellular telephone(s), laptop(s), handheld computer(s), camera(s), camcorder(s), television set-top box(es) or another device(s) capable of being integrated with a processor(s) that may operate as provided herein. Accordingly, the devices provided herein are not exhaustive and are provided for illustration and not limitation.

References to “a processor”, or “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A method comprising:
determining a first amount of tokens based on an interval occurring between receipt of a first packet and receipt of a second packet, the first packet received before the second packet;
determining a second amount of tokens based on a size of the second packet; and
updating a token bucket with the first amount of tokens as the second amount of tokens is removed from the token bucket.

2. The method as in claim 1, wherein determining the first amount of tokens based on the interval occurring between receipt of a first packet and receipt of a second packet includes:
calculating a product of an update interval and a configured rate, wherein the configured rate comprises a pre-determined amount of tokens with respect to a second interval, wherein the update interval comprises an amount of time occurring between (i) an update to the token bucket based on a size of the first packet and (ii) receipt of the second packet.

3. The method as in claim 1, wherein determining the second amount of tokens based on the size of the second packet includes:
calculating a total number of tokens to be deleted from the token bucket, wherein each token to be deleted corresponds to at least one byte in the second packet.

4. The method as in claim 3, wherein calculating the total number of tokens to be deleted from the token bucket includes:
if a current number of tokens in the token bucket is less than the total number of tokens to be deleted, identifying the second packet as eligible to be dropped:
based on the second packet being eligible to be dropped, determining that no tokens are to be deleted from the token bucket;
if the current number of tokens in the token bucket is greater than or equal to the total number of tokens to be deleted, identifying the second packet as a conformant packet; and
based on the second packet being a conformant packet, determining the total number of tokens to be deleted corresponds to an amount of bytes in the second packet.

5. The method as in claim 1, wherein updating the token bucket with the first amount of tokens as the second amount of tokens is removed from the token bucket includes:
performing a single read-from operation and a single read/modify write-to operation in order to (i) update the token bucket with the first amount of tokens and (ii) remove the second amount of tokens from the token bucket.

6. The method as in claim 5, wherein performing the single read/modify write to operation includes:
storing a time at which the token bucket is updated with the first amount of tokens.

7. The method as in claim 1, comprising:
prior to receipt of the first packet, placing a pre-determined maximum amount of tokens in the token bucket.

8. The method as in claim 7, wherein updating the token bucket with the first amount of tokens as the second amount of tokens is removed from the token bucket includes:
if the first amount of tokens is greater than the pre-determined maximum amount of tokens:
updating the token bucket with the pre-determined maximum amount of tokens; and
storing a time at which updating the token bucket with the pre-determine maximum amount of tokens occurred.

9. The method as in claim 1, comprising:
prior to receipt of the first packet, placing a pre-determined maximum amount of tokens in the token bucket;
wherein determining the first amount of tokens based on the interval occurring between receipt of a first packet and receipt of a second packet includes: calculating a product of an update interval and a configured rate, wherein the update interval comprises an amount of time occurring between (i) an update to the token bucket based on a size of the first packet and (ii) receipt of the second packet, wherein the configured rate comprises a pre-determined amount of tokens with respect to a second interval;
wherein determining the second amount of tokens based on the size of the second packet includes: calculating a total number of tokens to be deleted from the token bucket, wherein each token to be deleted from the token bucket corresponds to a respective byte in the second packet;
wherein calculating the total number of tokens to be deleted from the token bucket includes:
(i) if a current number of tokens in the token bucket is less than the total number of tokens to be deleted, identifying the second packet as eligible to be dropped;
(ii) upon identifying the second packet as eligible to be dropped, determining that no tokens are to be deleted from the token bucket;
(iii) if the current number of tokens in the token bucket is greater than or equal to the total number of tokens to be deleted, identifying the second packet as a conformant packet;
(iv) based on the second packet being a conformant packet, determining the total number of tokens to be deleted corresponds to an amount of bytes in the second packet; and
wherein updating the token bucket with the first amount of tokens as the second amount of tokens is removed from the token bucket includes: performing a single read-from operation and a single read/modify write-to operation in order to (a) update the token bucket with the first amount of tokens and (b) remove the second amount of tokens from the token bucket and (c) store a time at which the token bucket is updated with the first amount of tokens.

10. A non-transitory computer readable storage medium comprising executable instructions encoded thereon operable on a computerized device to perform processing comprising:
determining a first amount of tokens based on an interval occurring between receipt of a first packet and receipt of a second packet, the first packet received before the second packet;
determining a second amount of tokens based on a size of the second packet; and
updating a token bucket with the first amount of tokens as the second amount of tokens is removed from the token bucket.

11. The non-transitory computer readable storage medium as in claim 10, wherein determining the first amount of tokens based on the interval occurring between receipt of a first packet and receipt of a second packet includes:
calculating a product of an update interval and a configured rate, wherein the configured rate comprises a pre-determined amount of tokens with respect to a second interval, wherein the update interval comprises an amount of time occurring between (i) an update to the token bucket based on a size of the first packet and (ii) receipt of the second packet.

12. The non-transitory computer readable storage medium as in claim 10, wherein determining the second amount of tokens based on the size of the second packet includes:
calculating a total number of tokens to be deleted from the token bucket, wherein each token to be deleted corresponds to at least one byte in the second packet.

13. The non-transitory computer readable storage medium as in claim 12, wherein calculating the total number of tokens to be deleted from the token bucket includes:
if a current number of tokens in the token bucket is less than the total number of tokens to be deleted, identifying the second packet as eligible to be dropped:
based on the second packet being eligible to be dropped, determining that no tokens are to be deleted from the token bucket;
if the current number of tokens in the token bucket is greater than or equal to the total number of tokens to be deleted, identifying the second packet as a conformant packet; and
based on the second packet being a conformant packet, determining the total number of tokens to be deleted corresponds to an amount of bytes in the second packet.

14. The non-transitory computer readable storage medium as in claim 10, wherein updating the token bucket with the first amount of tokens as the second amount of tokens is removed from the token bucket includes:
performing a single read-from operation and a single read/modify write-to operation in order to (i) update the token bucket with the first amount of tokens and (ii) remove the second amount of tokens from the token bucket.

15. The non-transitory computer readable storage medium as in claim 14, wherein performing the single read/modify write to operation includes:
storing a time at which the token bucket is updated with the first amount of tokens.

16. The non-transitory computer readable storage medium as in claim 10, comprising:
prior to receipt of the first packet, placing a pre-determined maximum amount of tokens in the token bucket.

17. The non-transitory computer readable storage medium as in claim 16, wherein updating the token bucket with the first amount of tokens as the second amount of tokens is removed from the token bucket includes:
if the first amount of tokens is greater than the pre-determined maximum amount of tokens:
updating the token bucket with the pre-determined maximum amount of tokens; and
storing a time at which updating the token bucket with the pre-determine maximum amount of tokens occurred.

18. The non-transitory computer readable storage medium as in claim 10, comprising:
prior to receipt of the first packet, placing a pre-determined maximum amount of tokens in the token bucket;
wherein determining the first amount of tokens based on the interval occurring between receipt of a first packet and receipt of a second packet includes: calculating a product of an update interval and a configured rate, wherein the configured rate comprises a pre-determined amount of tokens with respect to a second interval, wherein the update interval comprises an amount of time occurring between (i) an update to the token bucket based on a size of the first packet and (ii) receipt of the second packet.
wherein determining the second amount of tokens based on the size of the second packet includes: calculating a total number of tokens to be deleted from the token bucket, wherein each token to be deleted from the token bucket corresponds to a respective byte in the second packet;
wherein calculating the total number of tokens to be deleted from the token bucket includes:
(i) if a current number of tokens in the token bucket is less than the total number of tokens to be deleted, identifying the second packet as eligible to be dropped;
(ii) upon identifying the second packet as eligible to be dropped, determining that no tokens are to be deleted from the token bucket;
(iii) if the current number of tokens in the token bucket is greater than or equal to the total number of tokens to be deleted, identifying the second packet as a conformant packet;
(iv) based on the second packet being a conformant packet, determining the total number of tokens to be deleted corresponds to an amount of bytes in the second packet; and
wherein updating the token bucket with the first amount of tokens as the second amount of tokens is removed from the token bucket includes: performing a single read-from operation and a single read/modify write-to operation in order to (a) update the token bucket with the first amount of tokens and (b) remove the second amount of tokens from the token bucket and (c) store a time at which the token bucket is updated with the first amount of tokens.

19. A computer system comprising:
a processor;
a memory unit that stores instructions associated with an application executed by the processor; and
an interconnect coupling the processor and the memory unit, enabling the computer system to execute the application and perform operations of:
determining a first amount of tokens based on an interval occurring between receipt of a first packet and receipt of a second packet, the first packet received before the second packet;
determining a second amount of tokens based on a size of the second packet; and
updating a token bucket with the first amount of tokens as the second amount of tokens is removed from the token bucket.

20. The computer system as in claim 19, comprising:
wherein determining the first amount of tokens based on the interval occurring between receipt of a first packet and receipt of a second packet includes:
calculating a product of an update interval and a configured rate, wherein the configured rate comprises a pre-determined amount of tokens with respect to a second interval, wherein the update interval comprises an amount of time occurring between (i) an update to the token bucket based on a size of the first packet and (ii) receipt of the second packet.
